(19) United States
(12) Patent Application Publication
(10) Pub. No.: US 2007/0005974 A1
(43) Pub. Date: Jan. 4, 2007

(54) Method for transferring encrypted data and information processing system

(75) Inventor: Yoshiyuki Kudou, Kawasaki (JP)

Correspondence Address: Patrick G. Burns, Esq.;GREER, BURNS & CRAIN, LTD, Suite 2500, 300 South Wacker Dr., Chicago, IL, 60606, US

(73) Assignee: FUJITSU LIMITED

(21) Appl. No.: 11/232,560

(22) Filed: Sep. 22, 2005

(30) Foreign Application Priority Data
Jun. 29, 2005 (JP) 2005-190036

(51) Int. Cl. H04L 9/00; H04K 1/00; G06F 12/14; H04L 9/32; G06F 11/30

(52) U.S. Cl. 713/171; 713/189; 713/186; 713/185

(57) ABSTRACT

A method for transferring encrypted data and an information processing system for implementing the method, wherein provisions are made to enhance the security of the encrypted data by allowing only the intended data recipient to handle the decryption key when transferring the encrypted data. In a computer network over which encrypted data is transferred between a data creating computer and a data receiving computer, the data creating computer includes an encryptor which encrypts plaintext data into encrypted data by using en encryption key transferred from the data receiving computer, and which transmits the encrypted data to the data receiving computer, and the data receiving computer includes an encryption key generator which generates the encryption key and transmits it to the data creating computer, and a decryptor which holds therein decryption key information corresponding to the encryption key in a form that cannot be copied, and which generates the decryption key based on the decryption key information and, using the decryption key, decrypts the encrypted data transferred from the data creating computer.

### BACKGROUND OF THE INVENTION

1. Field of the Invention

The present invention relates to a method for transferring encrypted data between a data-creating information processing system and a data-receiving information processing system, and an information processing system for implementing the method.

2. Description of the Related Art

In recent years, with the proliferation of networking, the importance of information security techniques has been growing; among others, the role of encryption techniques for maintaining the confidentiality of information is becoming increasingly important. Basic encryption schemes known in the art include common key encryption, which uses the same key for both encryption and decryption, and pubic key encryption, which uses a public key for encryption but requires a secret key for decryption.

For example, password-based encryption that uses a password as an encryption/decryption key is widely used. Password-based encryption known in the prior art has the problem that the security of encrypted data cannot be fully guaranteed because, if, as shown in FIG. 1, the encrypted data file being transferred from a data creator A to a data recipient B encounters an incident, such as loss, theft, or duplication, during the transfer, the password may be analyzed by a third party C using a brute-force attack or a like method.

Further, encrypted communication, such as shown in FIG. 2, is also practiced and uses, in addition to the password, specific information such as authentication information as part of the encryption/decryption key. As such authentication information is usually stored in a file or registry in a personal computer (PC), the information could be easily copied by a malicious third party. That is, there can occur a situation where, as shown in FIG. 2, the encrypted data file and authentication information stored on the PC of the recipient A are stolen or leaked and copied onto a computer of a third party C. In this case also, by receiving the analyzed password and reading out the authentication information, the encrypted data file can be successfully decrypted using a decryption program on the PC of the third party C.

As one prior art document concerning encryption techniques, Published Japanese translation of PCT application No. 2004-503969 discloses a technique that uses a variable encryption key created based on an encryption key of an authentication medium and unique information specific to computer hardware in order to authenticate the identity of the user passing through a service gate on the Internet. On the other hand, Japanese Unexamined Patent Publication No. 2000-267565 discloses a technique that prevents the removal of key recovery information from encrypted data containing the key recovery information. Further, Japanese Unexamined Patent Publication No. 11-031105 discloses a technique in which an authenticating means for authenticating the right to access data and a usage controlling means for allowing the access when the access right is authenticated are associated with the data and are together handled as a data capsule. Furthermore, Japanese Unexamined Patent Publication No. 2003-150559 discloses a technique that uses an arbitrary storage medium as a key in order to prevent unauthorized use of a computer.

### SUMMARY OF THE INVENTION

The present invention has been devised in view of the above problems, and an object of the invention is to enhance the security of encrypted data by allowing only the intended data recipient to handle the decryption key when transferring the encrypted data between a data-creating information processing system and a data-receiving information processing system.

To achieve the above object, according to the present invention, there is provided a method for transferring encrypted data between a data-creating information processing system and a data-receiving information processing system, comprising: an encryption key generating step in which the data-receiving information processing system generates an encryption key; an encryption key transmitting step in which the data-receiving information processing system transmits the encryption key to the data-creating information processing system; an encrypting step in which the data-creating information processing system encrypts plaintext data into encrypted data by using the encryption key transferred from the data-receiving information processing system, and transmits the encrypted data to the data-receiving information processing system; and a decrypting step in which the data-receiving information processing system, which holds therein decryption key information corresponding to the encryption key, generates a decryption key based on the decryption key information and, using the decryption key, decrypts the encrypted data which was encrypted in the data-creating information processing system.

In one preferred mode, the encryption key generating step generates the encryption key by including therein at least unique information specific to the data-receiving information processing system or to the recipient himself, and the decrypting step generates the decryption key when decrypting the encrypted data by acquiring the unique information in accordance with an algorithm for generating the decryption key corresponding to the encryption key.

In one preferred mode, the decrypting step, in advance, encrypts the decryption key corresponding to the encryption key generated in the encryption key generating step and stores the encrypted decryption key and, when decrypting the encrypted data, generates the decryption key by decrypting the encrypted decryption key.

In one preferred mode, the decryption key corresponding to the encryption key generated in the encryption key generating step is held in a program for implementing the decryption, and the decrypting step generates the decryption key when decrypting the encrypted data by extracting the decryption key from the program.

According to the present invention, there is also provided an information processing system for decrypting encrypted data, comprising: an encryption key generating unit which generates an encryption key; an encryption key transmitting unit which transmits the encryption key to another information processing system which creates the encrypted data by using the encryption key; and a decryption unit which holds therein decryption key information corresponding to the encryption key, and which generates a decryption key based on the decryption key information and, using the decryption key, decrypts the encrypted data which was encrypted in that other information processing system by using the encryption key.

In one preferred mode, the encryption key generating unit generates the encryption key by including therein at least unique information specific to the information processing system or to the recipient himself, and the decryption unit holds therein an algorithm for generating the decryption key corresponding to the encryption key and, when decrypting the encrypted data, generates the decryption key by acquiring the unique information in accordance with the algorithm.

Preferably, the unique information is unique information such as the MAC address of the information processing system, the serial number of the information processing system, the serial number of a storage device internal to the information processing system, or the serial number of an IC internal to the information processing system, or biometric information specific to the recipient, or unique identification information concerning the recipient's smart card or USB key, or a combination thereof.

In one preferred mode, the decryption unit, in advance, encrypts the decryption key corresponding to the encryption key generated by the encryption key generating unit and stores the encrypted decryption key and, when decrypting the encrypted data, generates the decryption key by decrypting the encrypted decryption key.

In one preferred mode, the decrypting unit holds, in a program for implementing the decryption, the decryption key corresponding to the encryption key generated by the encryption key generating unit and, when decrypting the encrypted data, generates the decryption key by extracting the decryption key from the program.

In one preferred mode, the information processing system further comprises: an encryption unit which encrypts plaintext data into encrypted data by using an encryption key transferred from another information processing system; and a data transmitting unit which transmits the encrypted data to that other information processing system.

Further, according to the present invention, there is also provided a security program for causing the above information processing system to perform its functions.

In the present invention, when transferring encrypted data, the decryption unit in the data-receiving information processing system, which holds therein, for example, an algorithm for generating the decryption key based on unique information specific to the data receiving system, stores the decryption key information in a form that cannot be copied; this serves to enhance the security of the encrypted data because only the data-receiving information processing system can handle the decryption key.

### BRIEF DESCRIPTION OF THE DRAWINGS

Further features and advantages of the present invention will be apparent from the following description with reference to the accompanying drawings, in which:

FIG. 1 is a diagram showing an example of theft and analysis of a password-based encrypted data file;

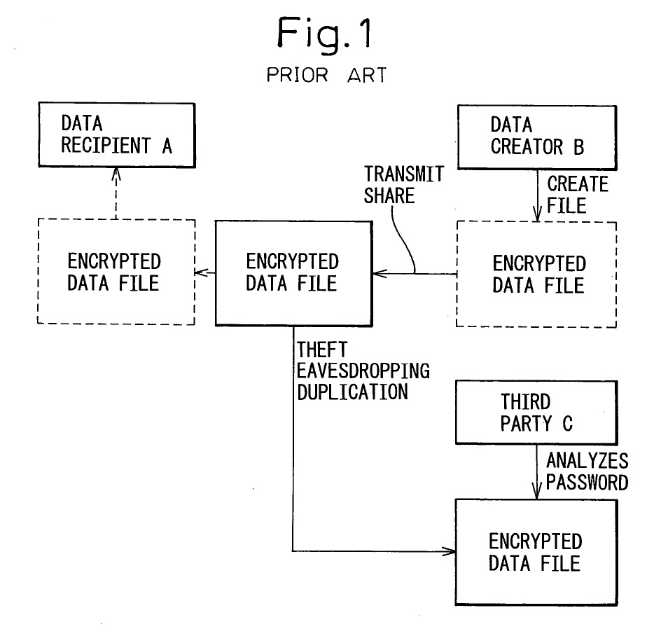

FIG. 2 is a diagram showing an example of leakage by dealing with the case where authentication information used as part of a decryption key is captured by a third party;

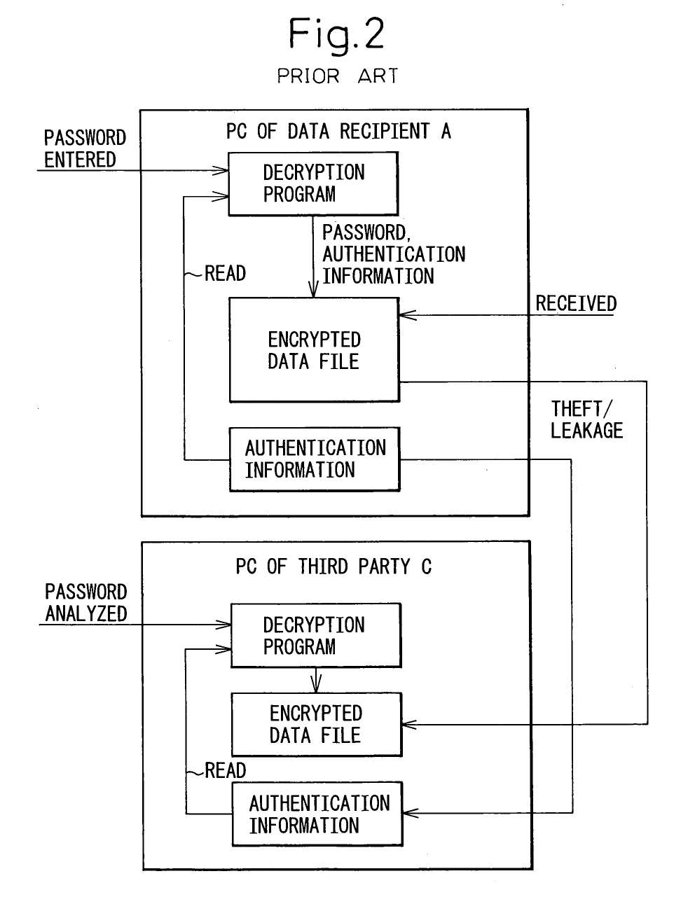

FIG. 3 is a block diagram showing a first embodiment of a computer network over which encrypted data is transferred in accordance with the present invention;

FIG. 4 is a flowchart illustrating an encrypted data transmission/reception procedure according to the first embodiment of the present invention, by including the case where the data has leaked out to a third party;

FIG. 5 is a block diagram showing a second embodiment of a computer network over which encrypted data is transferred in accordance with the present invention; and

FIG. 6 is a block diagram showing a third embodiment of a computer network over which encrypted data is transferred in accordance with the present invention.

### DESCRIPTION OF THE PREFERRED EMBODIMENTS

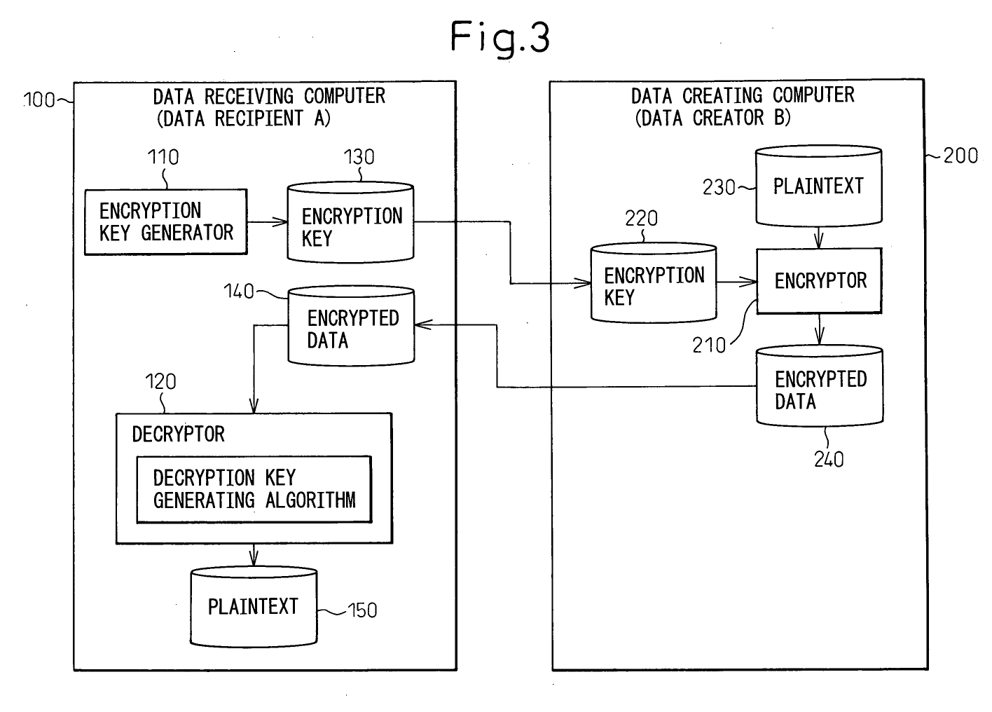

Embodiments of the present invention will be described below with reference to the accompanying drawings. FIG. 3 is a block diagram showing a first embodiment of a computer network over which encrypted data is transferred in accordance with the present invention. As previously described, when transferring and sharing an encrypted data file based on a password, if the encrypted data file leaks out for some reason during transmission along the communication path, there arises the problem that the password may be analyzed by a third person. To solve this problem, it has been practiced in the prior art to use, in addition to the password, specific information such as authentication information as part of the encryption key and to manage the encryption key separately so that the encryption key will not be intercepted on the same communication path; however, in this case also, if the encryption key itself leaks out, the encrypted data file will be successfully opened.

In view of this, in the first embodiment of the present invention, information that only the recipient can handle, for example, information unique to the recipient's computer (PC) or to the recipient himself, is used as the encryption key, with provisions made so that similar information that serves as the decryption key can be regenerated at the recipient's end for decryption; as a result, if the encryption key leaks out, persons other than the authorized recipient cannot generate the decryption key and open the encrypted data file.

The computer network of FIG. 3 is shown as including a data receiving computer 100 and a data creating computer 200 between which the encrypted data is transferred. The data receiving computer 100 and the data creating computer 200 each comprise a processor, memory, etc., and the processor executes software to functionally implement the various components shown in the figure.

The data creating computer 200 includes an encryptor 210; the encryptor 210 encrypts a plaintext data file 230 into an encrypted data file 240 by using an encryption key 220 transferred from the data receiving computer 100, and transmits the encrypted data file 240 to the data receiving computer 100. The encryptor 210 is implemented by running an encrypted data file creating program.

On the other hand, the data receiving computer 100 includes an encryption key generator 110 and a decryptor 120. The encryption key generator 110 generates an encryption key 130 and transmits it to the data creating computer 200, and is implemented by running an encryption key generating program. The decryptor 120 holds therein decryption key information corresponding to the encryption key 130 in a form that cannot be copied; when decrypting, the decryption key is generated based on the decryption key information and, using the decryption key, the encrypted data file 140 transferred from the data creating computer 200 is decrypted to recover the plaintext data file 150. The decryptor 120 is implemented by running a decryption program.

Specifically, the encryption key generator 110 in the first embodiment generates the encryption key 130 by including therein at least unique information specific to the data receiving computer 100 or the recipient himself. More specifically, the unique information is unique information specific to the data receiving computer 100, such as the MAC (Media Access Control) address of the data receiving computer 100, the serial number of the data receiving computer 100, the serial number of a storage device internal to the data receiving computer 100, or the serial number of an IC internal to the data receiving computer 100, or biometric information such as the recipient's fingerprint, or unique identification information concerning the recipient's smart card or USB key, or a combination thereof. Here, a MAC address is a physical address unique to a network device. The decryptor 120 holds therein an algorithm for generating the decryption key corresponding to the above encryption key and, at the time of decryption, generates the decryption key by acquiring the unique information in accordance with the algorithm.

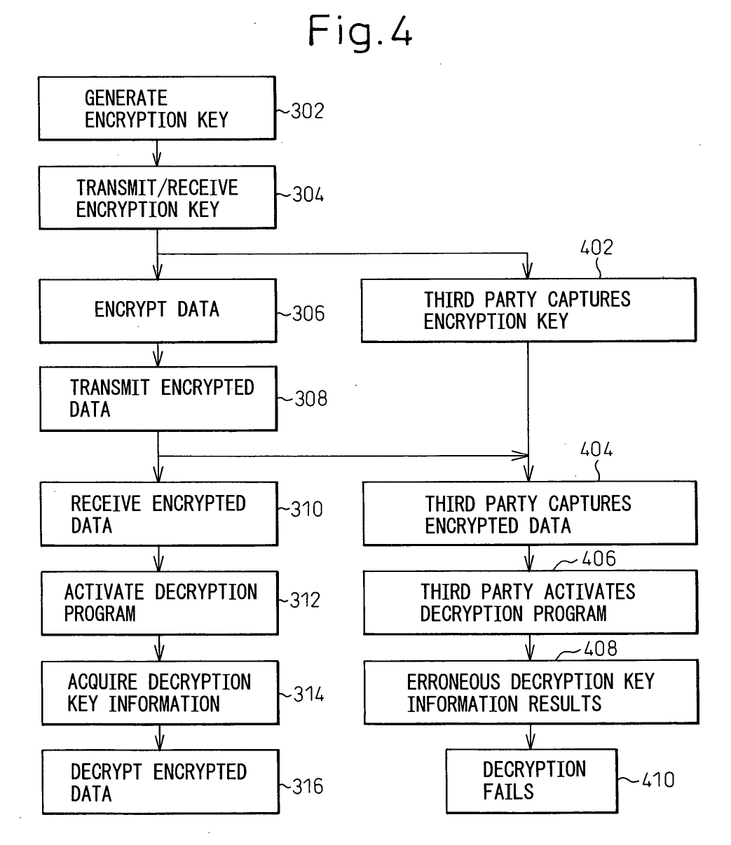

FIG. 4 is a flowchart illustrating the encrypted data transmission/reception procedure according to the first embodiment of the present invention, by including the case where the data has leaked out to a third party. First, in the data receiving computer 100, the encryption key generator 110, i.e., the encryption key generating program, activated by the recipient A generates the encryption key (step 302). More specifically, the encryption key generating program acquires the unique information specific to the data receiving computer (such as the MAC address of the computer or the serial number of the CPU) or the unique information specific to the recipient A himself (such as the fingerprint), and generates the encryption key by using one or the other of the unique information or a combination thereof and another suitable ID such as a password. The generated encryption key is stored in the form of a file, that is, as the encryption key file 130.

Next, under instruction from the recipient A, the encryption key generator 110 transmits the thus generated encryption key file 130 to the computer of the data creator B (step 304). The transmission is performed using, for example, one of the following methods conventionally used for data transfer.
The encryption key file by itself is transmitted by such means as e-mail.
The encryption key file is transmitted by appending a signature to it.
The encryption key file is transmitted by encrypting it with a one-time password.

Here, even if the encryption key file is stolen during transmission or reception, the data security of the encryption key file is maintained because, as will be described later, the encryption key file using the above encryption key cannot be decrypted on any computer other than the computer of the recipient A.

Next, in the data creating computer 200, the encryptor 210 activated by the data creator B, after receiving the encryption key file 220, extracts the encryption key by a suitable method, imports it into an encrypted data file generating program to make the encryption key ready for use, and generates the encrypted data file 240 by encrypting the plaintext data file with the encryption key (step 306). Here, if it is not desired to keep the encryption key file 220 stored in the environment of the data creator B after generating the encrypted data file, an algorithm for causing the encrypted data file generating program to delete the encryption key file 220 upon importation should be incorporated into the encrypted data file generating program.

Assuming the case where there is more than one data creator, if the data creator's ID predetermined between the data creator and the data recipient is added to the contents of the encryption key in step 306, it becomes possible to identify the validity of each encrypted data file creator.

Then, under instruction from the data creator B, the encryptor 210 transmits the encrypted data file 240 thus generated to the recipient A, i.e., to the data receiving computer 100 (step 308). Next, the data receiving computer 100 receives the encrypted data file and stores it as the encrypted data file 140 (step 310). Then, the decryptor 120, i.e., the decryption program, is activated by the recipient A (step 312).

The activated decryption program acquires the decryption key information (step 314). More specifically, the decryption program does not hold the decryption key at all times; rather, it internally holds a decryption key generating algorithm and generates, in accordance with the decryption key generating algorithm, the decryption key that contains the entered password and the unique information specific to the data receiving computer 100 or the recipient A, as when generating the encryption key (step 302). In this way, only the decryption key generating algorithm is incorporated in the decryption program, and the decryption key is generated using the specific algorithm each time the decryption is performed; with this provision, even if the decryption program is reverse engineered, the decryption key cannot be generated.

Finally, using the thus generated decryption key, the decryption program decrypts the encrypted data file 140 to recover the plaintext data file 150 (step 316). In this way, in the first embodiment, when decrypting the encrypted data file, the decryption program, upon activation, generates the decryption key and decrypts the encrypted data file using the thus generated decryption key.

On the other hand, in the event of leakage to the third party C, the process proceeds as follows. First, when the encryption key file is on the way from the data receiving computer 100 to the data creating computer 200, the encryption key file is captured by the computer of the third party C (step 402). Next, when the encrypted data file is on the way from the data creating computer 200 to the data receiving computer 100, the encrypted data file is captured by the computer of the third party C (step 404).

Next, in the computer of the third party C, a decryption program identical to the one stored in the data receiving computer 100 is activated by the third party C (step 406). The decryption program activated on the computer of the third party C acquires the decryption key information as in the previously described step 314 (step 408). However, the decryption program here generates the decryption key containing the unique information specific to the third party's computer or the third party himself. This decryption key, therefore, does not match the encryption key.

Then, the decryption program attempts to decrypt the captured encrypted data file by using the thus generated decryption key, but as the decryption key is an erroneous one, as just described, the decryption fails, resulting in an error condition (step 410).

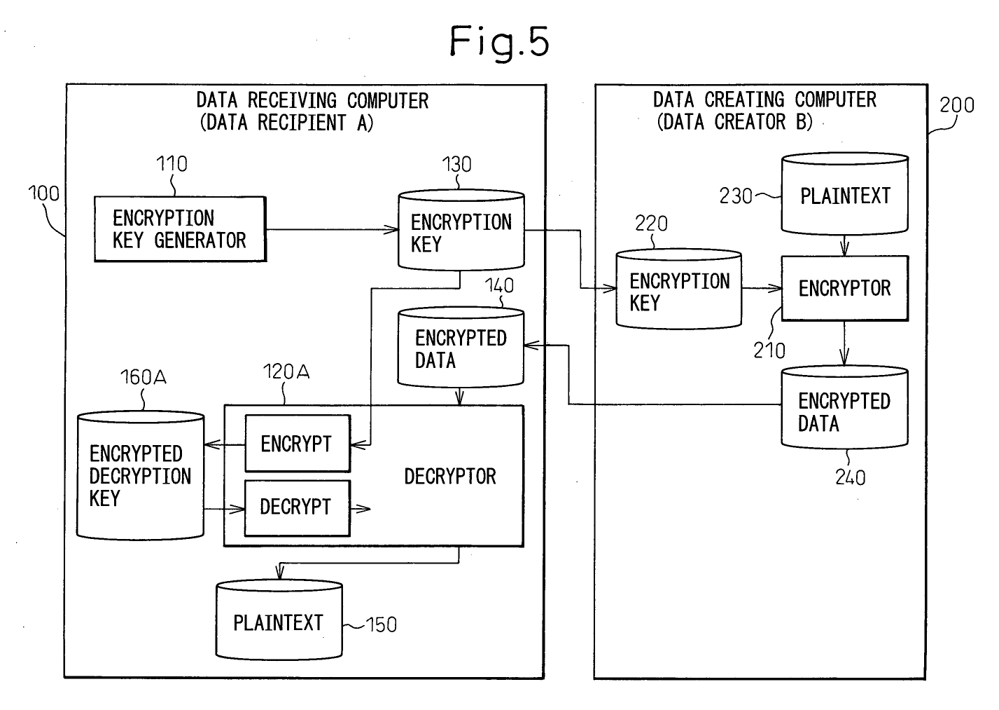

FIG. 5 is a block diagram showing a second embodiment of a computer network over which encrypted data is transferred in accordance with the present invention. As previously described, when storing at least part of the decryption key in the receiving computer, it has often been stored in a registry or a file. However, in the case of a registry or a file, the registry or file that holds the decryption key can be easily identified, and the decryption key is stored in the form that can be readily copied; therefore, there arises the problem that if the encryption key is taken out of the computer and falls into the hands of a malicious third party, and if the encrypted data file also falls into the hands of the third party, the third party can open the encrypted data file.

In view of this, the decryptor 120A in the second embodiment (FIG. 5) encrypts the decryption key, i.e., the encryption key 130 generated by the encryption key generator 110, and stores it as an encrypted decryption key 160A; then, at the time of decryption, the decryptor 120A generates the decryption key by decrypting the encrypted decryption key 160A.

In this way, in the second embodiment, as the decryption key is stored in an encrypted form in a file or registry, if a third party captures the decryption key information, the third party cannot utilize it. Accordingly, in the case of the second embodiment, the encryption key generator 110 need not necessarily generate the encryption key 130 by using the unique information specific to the data receiving computer or the recipient himself.

The encrypted data transmission/reception procedure according to the second embodiment is substantially the same as that in the first embodiment shown in FIG. 4. However, when acquiring the decryption key information in step 314, the decryption key storing file 160A is decrypted and the decryption key is extracted from it.

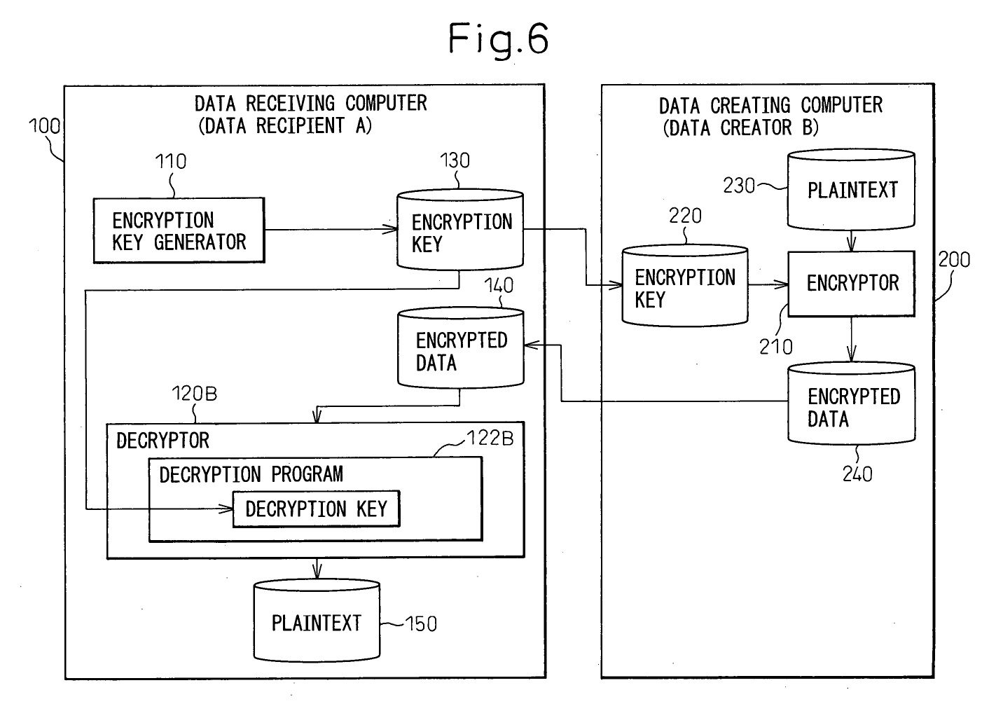

FIG. 6 is a block diagram showing a third embodiment of a computer network over which encrypted data is transferred in accordance with the present invention. If information is stored in a registry or file, the file that holds the decryption key tends to be easily identified from the increase or decrease in file size, etc. In view of this, the decryptor 120B in the third embodiment (FIG. 6) holds the decryption key, i.e., the encryption key 130 generated by the encryption key generator 110, within a decryption program 122B; then, at the time of decryption, the decryptor 120B generates the decryption key by extracting it from the decryption program 122B.

More specifically, a specific area is secured within the decryption program 122B, and the decryption key information is embedded in that area when installing the program. This eliminates the possibility of the location of the decryption key being guessed by a third party from the increase or decrease in file size, etc.

The encrypted data transmission/reception procedure according to the third embodiment is substantially the same as that in the first embodiment shown in FIG. 4. However, when acquiring the decryption key information in step 314, the decryption key information is extracted from the decryption program.

Here, as there is concern that the program containing the decryption key may be copied outside of the computer, some mechanism for preventing the program from being run on any other computer than that computer should be incorporated in the program. For example, part of the decryption program is encrypted using the MAC address of the computer and, when activating the program, the MAC address is acquired to decrypt the encrypted part of the decryption program.

In each of the embodiments of the present invention described above, as both the program for implementing the encryptor and the program for implementing the decryptor have similar algorithms, encrypted communications according to the present invention can be achieved by creating a single encryption and decryption program, that is, a security program. Further, each computer can usually be configured so as to be able to function as a data creating computer as well as a data receiving computer.

While each of the embodiments of the present invention has been described by dealing with computers, the present invention is applicable to various other information processing systems having information processing functions, such as mobile telephones or other portable information processing terminals.

Furthermore, while each of the embodiments of the present invention has been described by dealing with the case where the encrypted data is transmitted over a network, the encrypted data may be stored on a removable storage medium (such as a CD, DVD, MO, SD card, memory stick, or the like) and carried around or delivered by postal mail and may be configured so that it can be decrypted only by the recipient's system that transmitted the encryption key. Since measures are taken not only against erroneous transmissions on the network or against hackers, but also to prevent any system other the recipient's system from decrypting the data in case of the loss or theft of the removable storage medium, the security of the data can be protected reliably, and a system resistant to data leakage can be provided.

Accordingly, the present invention is not necessarily limited to a system in which encrypted data is transferred over a network.

The term “data” as defined in the appended claims, etc. includes various kinds of information such as software, files, and programs.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method for transferring encrypted data between a data-creating information processing system and a data-receiving information processing system, comprising:
generating an encryption key, wherein said data-receiving information processing system generates an encryption key;
transmitting an encryption key, wherein said data-receiving information processing system transmits said encryption key to said data-creating information processing system;
encrypting, wherein said data-creating information processing system encrypts plaintext data into encrypted data by using said encryption key transferred from said data-receiving information processing system, and transmits said encrypted data to said data-receiving information processing system; and
decrypting, wherein said data-receiving information processing system, which holds therein decryption key information corresponding to said encryption key, generates a decryption key based on said decryption key information and, using said decryption key, decrypts said encrypted data which was encrypted in said data-creating information processing system.

2. A method as claimed in claim 1, wherein said generating of an encryption key generates said encryption key by including therein at least unique information specific to said data-receiving information processing system or to a recipient himself, and said decrypting generates said decryption key when decrypting said encrypted data by acquiring said unique information in accordance with an algorithm for generating said decryption key corresponding to said encryption key.

3. A method as claimed in claim 2, wherein said unique information is unique information such as a MAC address of said data-receiving information processing system, a serial number of said data-receiving information processing system, a serial number of a storage device internal to said data-receiving information processing system, or a serial number of an IC internal to said data-receiving information processing system, or biometric information specific to said recipient, or unique identification information concerning said recipient's smart card or USB key, or a combination thereof.

4. A method as claimed in claim 1, wherein said decrypting, in advance, encrypts said decryption key corresponding to said encryption key generated in said generating of an encryption key and stores said encrypted decryption key and, when decrypting said encrypted data, generates said decryption key by decrypting said encrypted decryption key.

5. A method as claimed in claim 1, wherein said decryption key corresponding to said encryption key generated in said generating of an encryption key is held in a program for implementing said decryption, and said decrypting generates said decryption key when decrypting said encrypted data by extracting said decryption key from said program.

6. An information processing system for decrypting encrypted data, comprising:
an encryption key generating unit which generates an encryption key;
an encryption key transmitting unit which transmits said encryption key to another information processing system which creates said encrypted data by using said encryption key; and
a decryption unit which holds therein decryption key information corresponding to said encryption key, and which generates a decryption key based on said decryption key information and, using said decryption key, decrypts said encrypted data which was encrypted in said other information processing system by using said encryption key.

7. An information processing system as claimed in claim 6, wherein said encryption key generating unit generates said encryption key by including therein at least unique information specific to said information processing system or to a recipient himself, and said decryption unit holds therein an algorithm for generating said decryption key corresponding to said encryption key and, when decrypting said encrypted data, generates said decryption key by acquiring said unique information in accordance with said algorithm.

8. An information processing system as claimed in claim 7, wherein said unique information is unique information such as a MAC address of said information processing system, a serial number of said information processing system, a serial number of a storage device internal to said information processing system, or a serial number of an IC internal to said information processing system, or biometric information specific to said recipient, or unique identification information concerning said recipient's smart card or USB key, or a combination thereof.

9. An information processing system as claimed in claim 6, wherein said decryption unit, in advance, encrypts said decryption key corresponding to said encryption key generated by said encryption key generating unit and stores said encrypted decryption key and, when decrypting said encrypted data, generates said decryption key by decrypting said encrypted decryption key.

10. An information processing system as claimed in claim 6, wherein said decrypting unit holds, in a program for implementing said decryption, said decryption key corresponding to said encryption key generated by said encryption key generating unit and, when decrypting said encrypted data, generates said decryption key by extracting said decryption key from said program.

11. An information processing system as claimed in claim 6, further comprising:
an encryption unit which encrypts plaintext data into encrypted data by using an encryption key transferred from another information processing system; and
a data transmitting unit which transmits said encrypted data to said other information processing system.

12. A security program for causing an information processing system for decrypting encrypted data to function as:
an encryption key generating unit which generates an encryption key;
a transmitting unit which transmits said encryption key to another information processing system; and
a decryption unit which holds therein decryption key information corresponding to said generated encryption key, and which generates a decryption key based on said decryption key information and, using said decryption key, decrypts said encrypted data which was encrypted in said other information processing system.

13. A security program as claimed in claim 12, wherein said encryption key generating unit generates said encryption key by including therein at least unique information specific to said information processing system or to a recipient himself, and said decryption unit holds therein an algorithm for generating said decryption key corresponding to said encryption key and, when decrypting said encrypted data, generates said decryption key by acquiring said unique information in accordance with said algorithm.

14. A security program as claimed in claim 13, wherein said unique information is unique information such as a MAC address of said information processing system, a serial number of said information processing system, a serial number of a storage device internal to said information processing system, or a serial number of an IC internal to said data-receiving information processing system, or biometric information specific to said recipient, or unique identification information concerning said recipient's smart card or USB key, or a combination thereof.

15. A security program as claimed in claim 12, wherein said decryption unit, in advance, encrypts said decryption key corresponding to said encryption key generated by said encryption key generating unit and stores said encrypted decryption key and, when decrypting said encrypted data, generates said decryption key by decrypting said encrypted decryption key.

16. A security program as claimed in claim 12, wherein said decrypting unit holds, in a program for implementing said decryption, said decryption key corresponding to said encryption key generated by said encryption key generating unit and, when decrypting said encrypted data, generates said decryption key by extracting said decryption key from said program.

17. A security program as claimed in claim 12, wherein said information processing system is further caused to function as:
an encryption unit which encrypts plaintext data into encrypted data by using an encryption key transferred from another information processing system; and
a data transmitting unit which transmits said encrypted data to said other information processing system.
